(19) United States
(12) Patent Application Publication
(10) Pub. No.: US 2004/0045022 A1
(43) Pub. Date: Mar. 4, 2004

(54) Digital message insertion technique for analog video services

(76) Inventor: Steven Riedl, Superior, CO (US)

Correspondence Address: Derek J. Westberg, Two North Second Street, Suite 1390, San Jose, CA, 95113, US

(21) Appl. No.: 10/234,885

(22) Filed: Sep. 3, 2002

(51) Int. Cl. H04N 7/10; H04N 7/18

(52) U.S. Cl. 725/36; 725/78; 725/82; 725/85

(57) ABSTRACT

A digital program insertion technique for analog video services. In one aspect, a method and apparatus are provided for message insertion and delivery of video signals. A digital video program signal is received. A digital video message signal is inserted into the digital video program signal in response to an insertion cueing message. The inserting is performed while the digital video program and message signals remain in digital format, thereby forming a combined digital video signal. The combined digital video is then converted to an analog video signal. The analog video signal is distributed to a plurality of viewers using analog distribution equipment. Thus, the invention provides for the continued use of existing legacy equipment that distributes video signals in analog format. The combined digital video signals may also be delivered in digital format using equipment designed for digital video delivery. Accordingly, the present invention provides for use of newer equipment that processes and distributes video signals in digital format while retaining legacy equipment that distributes the video signals in analog format.

### BACKGROUND OF THE INVENTION

The present invention relates to video delivery services and, more particularly, to message insertion for video delivery services.

Television signals delivered to viewers generally include the television programs themselves and commercial advertisements, which are typically inserted into breaks that occur regularly during broadcasts of the television programs. The commercial advertisements are typically created and stored separately from the programs. Then, at appropriate times during a broadcast, the commercial advertisements are spliced into the video feed so as to deliver the advertisements to viewers during program breaks. This provides flexibility for changing the commercial advertisements to be played during a program. For example, various different advertisements directed to local audiences may be inserted into a program that is broadcast over a much wider geographical area. As another example, different advertisements may be used during a rebroadcast of a program than when the program was originally broadcast. Thus, an important aspect of television delivery is program splicing and, more particularly, ad insertion.

Traditionally, cable television delivery systems have processed video signals and delivered them to viewers in analog form. For example, magnetic tape-based systems have been used to perform program splicing for ad insertion. Then, cable plants distribute the spliced television signals to viewers in analog form. For example, fibre ring networks have been used to communicate analog television signals from a master headend to local headends. As a result, there currently exists a vast installed base of cable television equipment that is designed to process and transmit television programming as analog signals. More recently, schemes have become available for performing ad insertion and delivery of video programming to viewers using digital video signals. To implement these schemes, there is a need to replace existing analog equipment with equipment capable of processing and distributing television signals in digital form. However, a major impediment to the adoption of digital cable television networks is the cost associated with replacement of analog equipment with digital equipment.

Therefore, what is needed is technique for reducing the need to replace analog video equipment, while obtaining advantages of digital video signal processing and delivery schemes. It is toward these ends that the present invention is directed.

### SUMMARY OF THE INVENTION

The invention is a digital program insertion technique for analog video services. In one aspect, a method and apparatus are provided for message insertion and delivery of video signals. A digital video program signal is received (e.g., from a satellite). A digital video message signal is inserted into the digital video program signal in response to an insertion cueing message. The inserting is performed while the digital video program and message signals remain in digital format, thereby forming a combined digital video signal. The combined digital video is then converted to an analog video signal. The analog video signal is distributed to a plurality of viewers using analog distribution equipment.

In another aspect, the digital video signal channels may be distributed to a plurality of local headends via a fibre ring network. The digital video message may then be inserted into the digital video signal at one of the local headends.

The invention provides for the continued use of existing legacy equipment that distributes video signals in analog format. The combined digital video signals may also be delivered in digital format using equipment designed for digital video delivery. Accordingly, the present invention provides for use of newer equipment that processes distributes video signals in digital format while retaining legacy equipment that distributes the video signals in analog format.

### BRIEF DESCRIPTION OF THE DRAWINGS

FIG. 1 illustrates a block schematic diagram of a video signal insertion and delivery system in accordance with the present invention; and

FIG. 2 illustrates a block schematic diagram of an alternate video signal insertion and delivery system in accordance with the present invention.

### DETAILED DESCRIPTION OF A PREFERRED EMBODIMENT

The present invention provides a technique for digital program insertion for analog video services. In accordance with the present invention, video signals are spliced in digital format. Thus, the invention takes advantage of digital techniques for performing ad insertion. For example, audio level matching may be performed using audio metadata (e.g., Dolby Digital metadata). Once combined (i.e. by splicing), the digital video signals are converted to analog format and then distributed to viewers in analog format. Thus, the invention provides for the continued use of existing legacy equipment that distributes video signals in analog format. The combined digital video signals may also be delivered in digital format using equipment designed for digital video delivery. Accordingly, the present invention provides for use of newer equipment that processes and distributes video signals in digital format while retaining legacy equipment that distributes the video signals in analog format. Because legacy equipment can continue to be used, the invention allows video service providers to add digital insertion and distribution equipment to their existing analog networks. Accordingly, the distribution equipment can be gradually changed or added, as desired, to perform digital video signal processing, thereby spreading out the cost of doing so over time.

While the discussion herein is primarily directed to processing and distribution of video signals for a cable television system, it will be apparent that the present invention may be used in other video signal processing and/or communication systems. In addition, while program splicing is discussed in the context of inserting commercial advertisements, it will be apparent that program splicing in accordance with the invention can be employed for other purposes, such as for program editing or for distribution of public announcements or other messages. Also, it will be apparent that associated audio signals generally accompany the video signals as they are processed and distributed, using techniques appropriate for the audio signals.

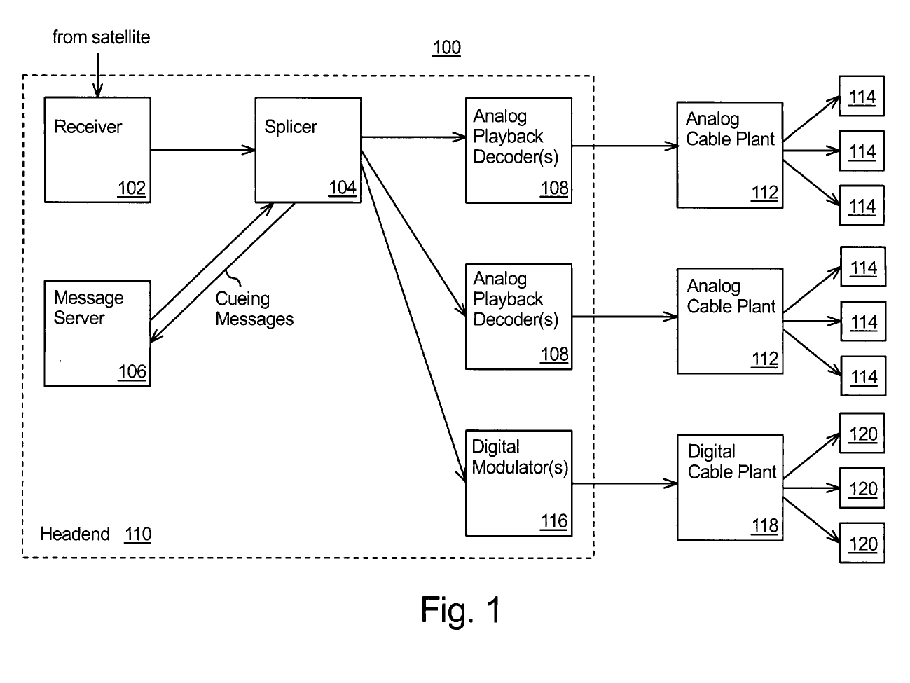

FIG. 1 illustrates a block schematic diagram of a video signal insertion and delivery system 100 in accordance with the present invention. Video signals are received into a receiver 102. Generally, these video signals are in a multiplex that includes multiple program channels encrypted and modulated onto a carrier signal that is received from a satellite system. For example, the video signals may be modulated in accordance with quadrature phase shift keying (QPSK) techniques. Each program channel received by the receiver 102 will generally include cueing information that indicates the locations of program breaks for inserting commercial advertisements or other messages.

The receiver 102 typically demodulates and decrypts the program channel signals. Thus, the receiver 102 may be referred to as a multi-decrypting receiver. The receiver 102 may then convert the signals to compressed Moving Picture Experts Group (e.g., MPEG-2) streams along with audio in Dolby Digital AC-3 format. Specifically, the video signals formed by the receiver 102 may be, for example, an unencrypted multiplex of the video channels in the accordance with Digital Video Broadcast-Asynchronous Serial Interface (DVB-ASI) or Motorola Digital Headend Electronic Interface (DHEI) standards.

A splicer 104 receives the video signals from the receiver 102. The splicer 104 retrieves cueing information from each program channel and, in response, forms cueing messages. In one aspect, the cueing messages are in accordance with standards promulgated by the Society of Cable Telecommunication Engineers (SCTE), known as Digital Program Insertion (DPI). The cuing messages are communicated to a video message or ad server 106.

The message server 106 stores a number of prerecorded commercial advertisements or other messages ready for delivery to the splicer 104. For example, the commercial advertisements may be in the form of compressed MPEG-2. In response to the cueing messages, the message server 106 provides selected commercial advertisements to the splicer 104 at appropriate times. The splicing is generally performed during the broadcast (i.e. while the program is being viewed by subscribers), though in some circumstances, it may be desired to perform the splicing in advance.

The splicer 104 then inserts the commercial advertisements into breaks in each of the programs so as to form a combined signal for each channel. Where the splicer 104 receives a multiplex of the channels, the splicer 104 may separate the multiplex into the individual channels prior to splicing video messages from the message server 106 into the individual channels. Then, the splicer 104 may perform statistical multiplexing on the combined signals (i.e. the spliced signals) to regenerate a multiplex of the channels.

The output of the splicer 104 is then delivered to one or more analog playback decoders 108. While two such decoders are shown, it will be apparent that more of fewer analog decoders 108 may be provided, depending on the circumstances. For example, each decoder 108 may handle a limited number of channels (e.g., six) and, thus, additional decoders 108 may be required depending upon the number of channels to be distributed. The receiver 102, splicer 104, message server 106, and analog playback decoders 108 may be located at the headend 110 of a cable operator.

The analog playback decoders 108 convert the digital video signals received from the splicer 104 to analog format. The analog signals may then be modulated onto a carrier signal for distribution to subscribers 114 via one or more cable plants 112. Because the video signals from the analog playback decoders 108 are in analog form, the cable plant(s) 112 and subscribers 114 need not have specialized digital equipment for processing the signals. Rather, the cable plant(s) 112 may include legacy analog equipment, while the subscribers 114 may receive the signals using conventional television sets without special equipment, such as a set top box (STB).

In addition, the multiplex may be delivered to one or more digital signal modulators 116, which may also be located at the headend 110. The modulators 116 modulate the video signals onto a carrier signal for distribution to subscribers 120, via one or more cable plant(s) 118. More particularly, an up-converted and modulated signal from the modulator 116 may be forwarded to the cable plant(s) 118 and then to subscribers 120. For modulating the digital video signals onto a carrier for distribution, quadrature amplitude modulation (QAM) techniques may be employed at the modulators 116. Because the video signals from the modulator 116 are communicated in digital form, the cable plant(s) 118 and subscribers 120 will need to have appropriate equipment for processing the digital signals. For example, each subscriber 120 may be required to have a digital set top box (STB).

Though one digital modulator 116 is shown, it will be apparent that more modulators 116 may be utilized depending on the circumstances, such as the number of channels to be distributed. Alternately, where video distribution is performed entirely by analog equipment (e.g., analog cable plants 112), the digital signal modulators 116 and associated digital distribution equipment (e.g., digital plants 118) may be omitted from the system 100.

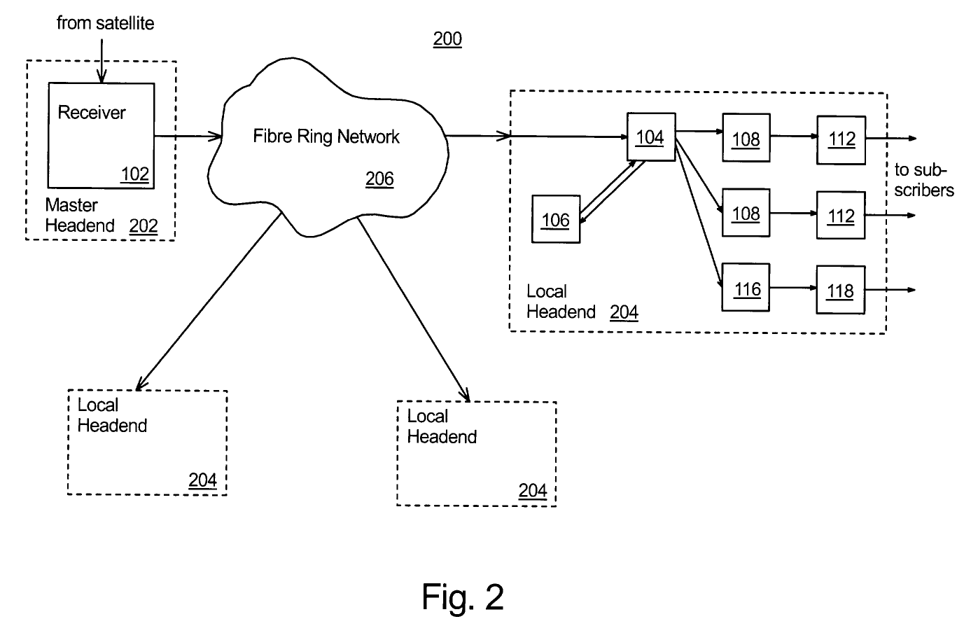

FIG. 2 illustrates a block schematic diagram of an alternate video signal insertion and delivery system 200 in accordance with the present invention. FIG. 2 differs from FIG. 1 principally in that the functions of the headend 110 of FIG. 1 are divided among a master headend 202 and local headends 204. In addition, a network, such as a fibre ring network 206, provides for communication among the master headend 202 and local headends 204.

The master headend includes the receiver 102. Digital video signals from the receiver 102 are forwarded to the fibre ring network 206 and distributed in digital format via the fibre ring 206 to the local headends 204. In this manner, the bandwidth requirements for the fibre ring 206 are reduced significantly in comparison to conventional systems in which a fibre ring may be used to distribute analog video signals. Each local headend 204 may include a splicer 104 and a message server 106 for performing program splicing in digital format. Once the splicing is completed, the combined signals in digital format may be forwarded to one or more analog playback decoders 108 where they are converted to analog format for distribution to subscribers via cable plants 112.

Thus, in accordance with the embodiment of FIG. 2, an existing fibre ring network 206 may be used to communicate digital video signals to subscribers. In addition, the cable plant(s) 112 and subscribers 114 need not have specialized digital equipment for processing the signals. Rather, the cable plant(s) 112 may include legacy analog equipment, while the subscribers 114 may receive the signals using conventional television sets without special equipment, such as a set top box (STB).

In addition, the digital video signals from the fibre ring 206 may be delivered to one or more digital signal modulators 116, which may also be located at the local headends 204. The modulators 116 modulate the video signals onto a carrier signal for distribution to subscribers via one or more digital cable plant(s) 118. Because the video signals from the modulator 116 are communicated in digital form, the cable plant(s) 118 and subscribers 120 will need to have appropriate equipment for processing the digital signals (e.g., a set top box).

In an alternate embodiment of the system 200 of FIG. 2, a splicer 104 and message server 106 may be located in the master headend 202. In this case, once the splicing is performed, the combined signals may then be distributed in digital format via the fibre ring 206 to the local headends 204. At the local headends 204, the digital video signals are converted to analog video signals by analog decoders 108 for distribution in analog format. In addition, at the local headends 204, the digital video signals may be distributed in digital format by modulators 116 and cable plants 118.

Thus, techniques have been described for reducing the need to replace analog video equipment, while obtaining advantages of digital video signal processing and delivery schemes.

While the foregoing has been with reference to particular embodiments of the invention, it will be appreciated by those skilled in the art that changes in these embodiments may be made without departing from the principles and spirit of the invention, the scope of which is defined by the appended claims.

What is claimed is:

1. A method for message insertion and delivery of video signals comprising:
receiving a digital video program signal;
inserting a digital video message signal into the digital video program signal in response to an insertion cueing message, wherein said inserting is performed while the digital video program and message signals remain in digital format, thereby forming a combined digital video signal; and
converting said combined digital video to an analog video signal; and
distributing the analog video signal to a plurality of viewers.

2. The method according to claim 1, wherein said receiver is a multi-decrypting receiver and said digital program signal is encrypted prior to being received by the multi-decrypting receiver.

3. The method according to claim 1, wherein said receiver receives an encrypted multiplex of digital video program signals and forms an unencrypted multiplex of the digital video program channels.

4. The method according to claim 3, wherein said inserting is performed by a splicer and wherein said splicer separates the unencrypted multiplex into individual channels prior to inserting the video messages into the individual channels and forms regenerated multiplex of the channels after inserting the video messages into the individual channels.

5. The method according to claim 1, wherein the digital video signal from the receiver includes a cueing packet and further comprising generating said cueing message in response to said cueing packet.

6. The method according to claim 5, wherein said cueing message is in accordance with Digital Program Insertion (DPI).

7. The method according to claim 1, further comprising modulating the combined digital video signal to a carrier signal for distribution to subscribers in digital format.

8. The method according to claim 1, further comprising distributing the digital video signal channels to a plurality of local headends via a fibre ring network prior to performing said inserting at one of said local headends.

9. An apparatus for message insertion and delivery of video signals comprising:
a receiver for receiving and forwarding a plurality of digital video program channels;
a message server for storing a plurality of video messages and for selectively providing said video messages in digital format in response to insertion cueing messages;
a splicer coupled to the receiver and to the message server for generating said insertion cueing messages and for inserting said video messages into said digital video program channels, thereby forming a plurality of combined digital video signals; and
at least one analog decoder for converting the combined digital video signals to analog format for distribution to subscribers.

10. The apparatus according to claim 9, wherein said receiver is a multi-decrypting receiver and said plurality of program channels are encrypted prior to being received by the multi-decrypting receiver.

11. The apparatus according to claim 9, wherein said receiver receives an encrypted multiplex of the digital video program channels and forms an unencrypted multiplex of the digital video program channels.

12. The apparatus according to claim 11, wherein said splicer separates the unencrypted multiplex into individual channels prior to inserting the video messages into the individual channels and forms a regenerated multiplex of the channels after inserting the video messages into the individual channels.

13. The apparatus according to claim 9, wherein each digital video program signal from the receiver includes a plurality of cueing packets and wherein said splicer generates said cueing messages in response to said cueing packets.

14. The apparatus according to claim 13, wherein said cueing messages are in accordance with Digital Program Insertion (DPI).

15. The apparatus according to claim 9, further comprising at least one digital modulator for receiving the combined digital video signal and modulating the digital video signals to a carrier signal for distribution to subscribers.

16. The apparatus according to claim 15, further comprising a digital cable plant for distributing the digital video signals to subscribers.

17. The apparatus according to claim 16, further comprising an analog cable plant for distributing the analog video signals to subscribers.

18. The apparatus according to claim 9, further comprising:
a fibre ring network for communicating the plurality of digital program channels from the receiver to the splicer; and
one or more additional splicers for receiving the plurality of digital program channels from the fibre ring and each splicer being coupled to an additional message server, wherein each pair of an additional splicer and a message server is located in a local headend for inserting messages at the local headend.

19. The apparatus according to claim 9, further comprising a fibre ring network for distributing said combined digital video signals to a plurality of local headends, said analog decoder being located in one of said local headends.

20. An apparatus for message insertion and delivery of video signals comprising:
a master headend including a receiver for receiving and forwarding a plurality of digital video program channels;
a fibre ring network for distributing the plurality of digital program channels from the receiver;
a plurality of local headends for receiving the plurality of digital program channels from the fibre ring and each local headend including a splicer and a message server for inserting digital video messages at the local headend thereby forming a plurality of combined digital video signals; and
an analog decoder for converting the combined digital video signals at one of the local headends to analog format for distribution to subscribers.

21. The apparatus according to claim 20, further comprising a digital modulator for receiving the combined digital video signal at one of the local headends and modulating the digital video signals to a carrier signal for distribution to subscribers.
